(19) United States
(12) Patent Application Publication
(10) Pub. No.: US 2007/0062055 A1
(43) Pub. Date: Mar. 22, 2007

(54) T-square adapted to secure sheet material

(76) Inventor: Michael Skelskey, Bristol, CT (US)

Correspondence Address: Michael Skelskey, 128 Washington Street, Bristol, CT, 06010, US

(21) Appl. No.: 11/228,744

(22) Filed: Sep. 16, 2005

(51) Int. Cl. B43L 13/00

(52) U.S. Cl. 33/479

(57) ABSTRACT

A T-square includes a first member defining a straight edge, a second member that is mounted transverse to the first member and defining a free end spaced from the straight edge, and sheet material securing means mounted to and extending beyond that free end. In various embodiments, the securing means holds sheet material in compression against the straight edge of the first member or in compression against an undersurface of the second planar member, or both. The securing means may be a clamp that is moved toward the straight edge by a threaded shaft, or it may be a biasing member such as spring steel that holds sheet material in compression against the straight edge or against both the straight edge and against the second planar member.

### TECHNICAL FIELD

The present invention relates to construction tools, and particularly relates to a T-square adapted to secure a sheet of material against it for easier marking and cutting.

### BACKGROUND

T-squares are widely used in the construction industry for measuring and marking sheet material such as plywood and sheet rock (gypsum board). They are also used as a guide for cutting such sheet material.

For sheet rock and other such materials that are typically cut by scoring and snapping, a razor or other thin blade is drawn against an edge of the t-square to score an initial cut line along the length of the T-square. The T-square is then removed and the sheet material is snapped away from the score line to affect a break through the material along the score line. A paper backing opposite the score line is then cut with the blade to separate the two sections. Some constructions crews instead hold the razor against a terminal edge of a tape measure, and align a measure mark against a finished edge of the sheet material. By drawing the extended length of the tape measure along a length of the sheet material while imposing the edge of the blade into the sheet rock, a similar score line can be imposed without the additional step of using the T-square. This often results in a less than straight line, and generally requires the craftsman to take additional time to separately score edges of the sheet rock to reduce the risk that the very edges of the sheet rock snap along an erratic line separate from the score line. While minor imperfections from a less than straight cut of sheet rock are readily concealed during taping and finishing of sheet rock walls and ceilings, the end result generally incurs additional labor in filling and sanding gaps that are larger than would be the case if straighter score lines were used.

For more resilient material such as plywood, the T-square is generally used for marking a straight line which is then used as a manual guide for a circular or other type of saw. While the measured and marked line from the T-square may be straight, the resulting cut generally is by manually following the drawn line with a saw. Due to sawdust partially obscuring a viewer's alignment of the saw blade with the marked line, and concern for cutting debris getting into the craftsman's eyes or behind his safety glassed when closely comparing the saw blade's travel along the line, the resulting saw cut is often less straight than optimal, especially over extended cut lengths. This results in underlayment gaps. Nails may be driven through a roofing shingle for example, unknown to the roofer using a pneumatic nailing gun, leaving the shingle less secure and subject to being separated from the underlayment during a moderate windstorm.

The construction industry is both competitive and labor intensive, so proposed improvements to techniques and material are generally widely adopted only when such improvements save labor or improve safety without severely diminishing efficiency. What is needed in the art is an apparatus to efficiently enable resulting cuts in sheet material to be straighter than is generally the case with the above techniques. The present invention adapts a T-square for such a purpose.

### SUMMARY

The foregoing and other problems are overcome, and other advantages are realized, in accordance with the presently preferred embodiments of these teachings.

In accordance with one embodiment, the present invention is a T-square that includes a first member defining a straight edge and a second member that is mounted transverse to the first member and defining a free end spaced from the straight edge. Transverse means preferably perpendicular, though any angle between the longest relative longitudinal axes of the first and second members suffices as transverse. The T-square further includes sheet material securing means mounted to and extending beyond that free end. In various embodiments, the securing means holds sheet material in compression against the straight edge of the first member or in compression against an undersurface of the second planar member, or both.

In accordance with another embodiment, the present invention is an apparatus for mounting to a T-square. Such an apparatus includes a plate for securing to a planar member of a T-square, near a free end of that planar member. The apparatus further includes, coupled to the plate, means for holding sheet material in compression against said T-square.

Further details and embodiments are detailed below.

### BRIEF DESCRIPTION OF THE DRAWINGS

The foregoing and other aspects of these teachings are made more evident in the following Detailed Description, when read in conjunction with the attached Drawing Figures, wherein:

FIG. 1 is a top view of a T-square in accordance with one embodiment of the invention.

FIG. 2A is an isolation view of a clamp assembly illustrated in FIG. 1.

FIG. 2B is a view along section lines 2B-2B of FIG. 1.

FIG. 2C is a sectional view of the clamp assembly along section lines 2C-2C of FIG. 1.

FIG. 2D is an exploded view of the clamp assembly of FIG. 1.

FIG. 3 is a top view of another embodiment of the invention.

FIG. 4A is a closer view of the securing assembly illustrated in FIG. 3.

FIG. 4B is a plan view of the securing assembly along lines 4B-4B of FIG. 3.

It is noted that the specific measurements presented in the drawings are exemplary only.

### DETAILED DESCRIPTION

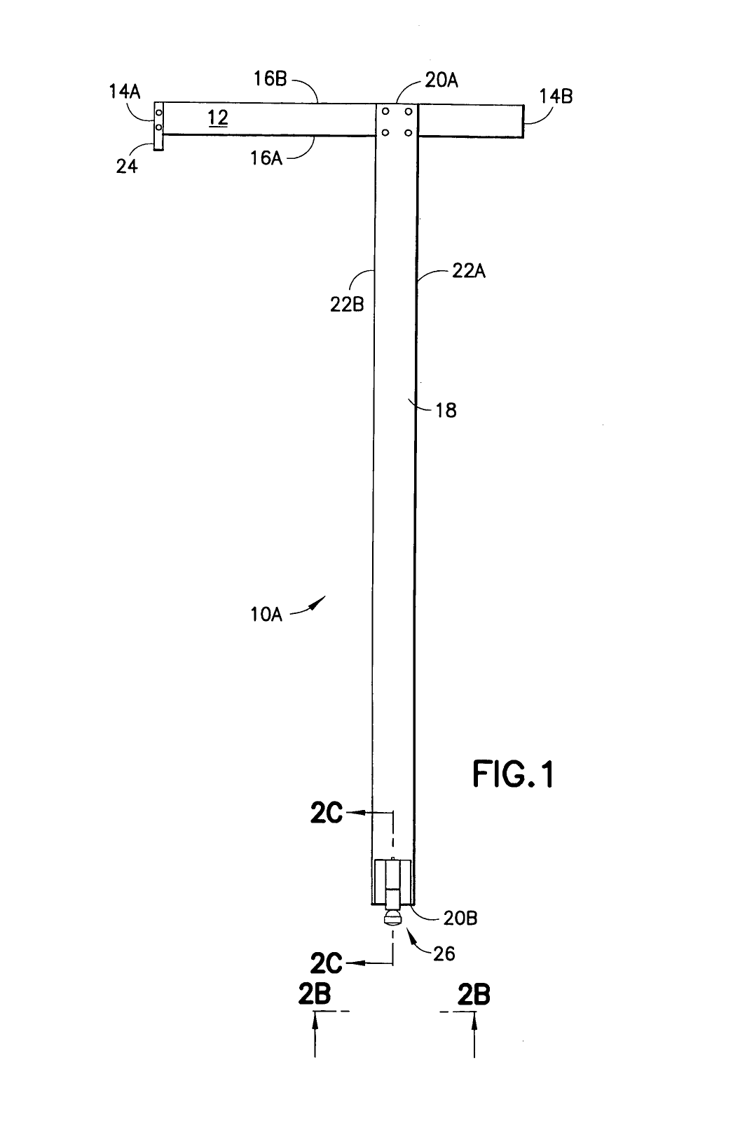

A T-square is well known in the construction arts and is described in accordance with relevant portions of FIG. 1 for clarity of the following description of the invention. A first member 12 defines a first end 14A and an opposed second end 14B along the length of the first member 12. A straight edge 16A spans between the first 14A and second 14B edges of the first member, and is for abutting an edge of sheet material on which the T-square is used to measure, score, or otherwise operate. An opposing edge 16B is also generally straight. The first member 12 is typically planar along the surface illustrated in FIG. 1 and its opposed undersurface. A second planar member 18 is typically longer than the first member 12, and defines a first end 20A and an opposed free end 20B along its length. A straight edge 22A is typically used to draw straight lines or score. An opposed edge 22B is typically also straight, and may be used for drawings lines or scoring but typically used much less often than its opposite straight edge 22A. The second planar member is planar along the surface illustrated in FIG. 1, and along its opposed undersurface. The second planar member 18 is attached to the first member 12, typically such that the first edge 20A of the second planar member 18 is in alignment with the opposed edge 16B if the first member 12 at a location between the first 14A and second 14B ends of the first member 12, as illustrated. The opposed undersurface of the second planar member 18 is mounted to the illustrated surface of the first member 12 so that a sheet of material to be worked abuts the straight edge 16A of the first member 12 and a broad generally planar surface of the sheet material lies flush with the opposed undersurface of the second planar member 18. Typically, the distance between the straight edge 16A of the first member 12 and the free end 20B of the second planar member 18 is forty eight inches in the United States, for ready use with uncut sheet material such as 4′ by 8′ plywood or sheet rock. The first member 12 and second planar member 18 are preferably made from aluminum, steel, or some other metal that is resistant to cuts from razor and saw blades, and are substantially self-supporting along their lengths though some deflection is allowable.

Particular inventive aspects of the first embodiment are now described. A stabilizer tab 24 is mounted atop the illustrated surface of the first member 12 so that an undersurface thereof lies in substantially the same plane as the undersurface of the second planar member 18. The stabilizer tab 24 extends beyond the straight edge 16A of the first member to prevent rotation of the first embodiment of the T-square 10A about the second planar member 18, at least in one rotation direction. Preferably, the distance between the stabilizer tab 24 and the second planar member 18 is greater than the distance between the second planar member 18 and the end 14B of the first member 12 that is nearest to the second member 18.

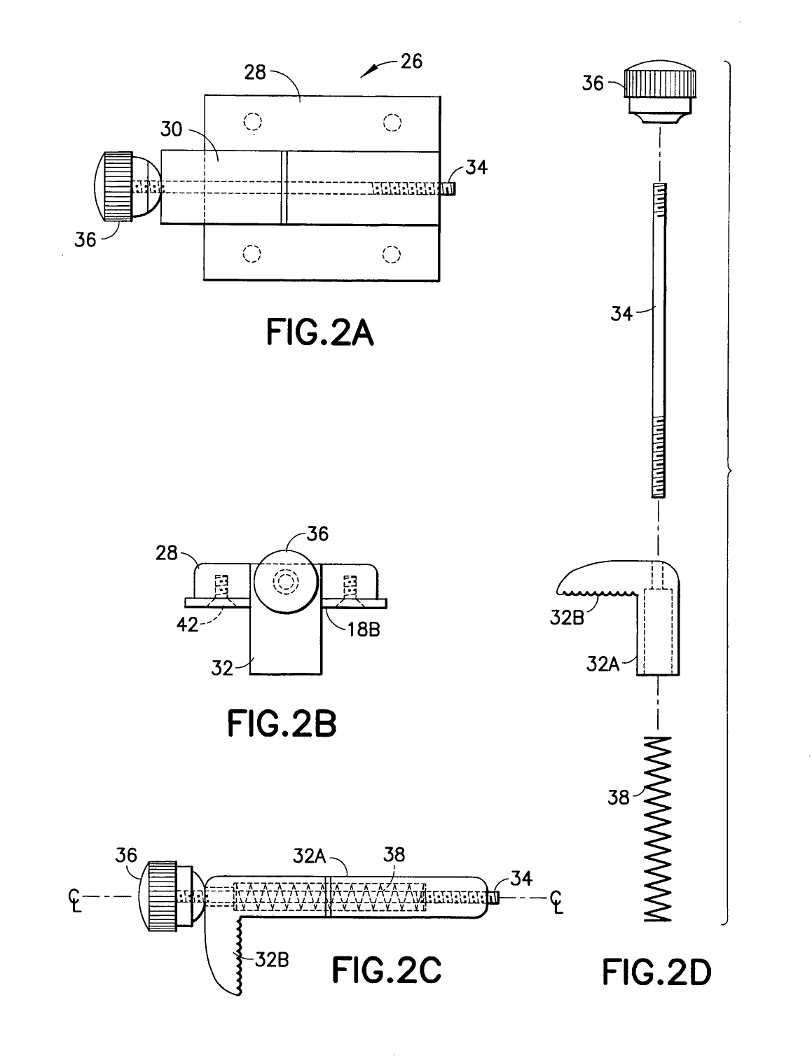

Mounted near the free end 20B is a clamp assembly 26 for securing sheet material in compression against the straight edge 16A of the first member. FIGS. 2A-2D illustrate detail of the clamp assembly 26. The clamp assembly includes a plate 28 for securing to the second planar member 18 near the free end 20B. As illustrated in FIG. 2B, the plate 28 is secured via screws to the surface of the second planar member 18 illustrated in FIG. 1, and the screws lie flush with the undersurface 18B of that second planar member 18. A housing is mounted to the plate 28 opposite the second planar member 18, and defines a receptacle for receiving a shaft section 32A of a clamp 32. A jaw section 32B of the clamp 32 remains outside the aperture of the housing and extends beyond the free end 20B of the second planar member 18 and below the undersurface 18b thereof, the undersurface 18B being that surface against which sheet material generally lies when the T-square 10A is in use.

The shaft 32A of the clamp 32 also defines an aperture through which a rod 34 penetrates. Preferably, the rod 34 is threaded at both opposed ends though only one end need be threaded. A knob 36 is attached to one end of the rod 34, and a mating threaded section of the aperture of the housing receives the opposed end of the rod 34. A helical coil spring 38 surrounds a portion of the rod 34 and serves to bias the jaw 32B away from the free end 20B of the second planar member 18, and away from the straight edge 16A of the first member 12. The rod 34 may be fixed within the housing 30, or fixed to the knob 36, but not to both. Where both ends of the rod 34 are threaded, the threads should run the same direction so that rotation of the knob 36 in one direction draws the jaw 32B toward the free end 20B, and rotation of the knob 36 in the opposite direction allows the spring 38 to bias the jaw 32B away from the free end 20B. The spring 38 may lie within the aperture of the shaft 32A of the clamp 32, or may abut an end of the shaft 32A opposite the jaw 32B.

In operation, rotation of the knob 36 in one direction draws the jaw 32B toward the free end 20B, so that sheet material abutting the undersurface 18B of the second planar member 18 is secured against the straight edge 16A of the first member 12 in compression. The stabilizer tab 24 aids in preventing rotation of the entire T-square relative to the sheet material while the knob 36 is being rotated. Once so secured, the T-square 10A may be used to draw a line along the straight edge 22A or opposed edge 22B of the second planar member 18, and either of those edges 22A, 22B may also be sued as a guide for cutting resilient sheet material, such as cutting plywood with a circular saw. A simple rotation of the knob 36 in the opposite (release) direction when the saw is near the straight edge 16A of the first member 12 causes the spring 38 to move the jaw 32B away form the free end 20B and the sheet material, enabling a craftsman to move the T-square 10A away and complete the last inch or so of the cut through the sheet material. Alternatively, the first member 12 and second planar member 18 may be secured to one another such that the straight edge 22A of the second planar member 18 lies flush with the second end 14B of the first member 12, enabling a craftsman to cut through an entire four-foot length of sheet material without having to release the T-square 10A via the knob 36.

While the plate 28 and housing 30 of the clamp assembly 26 do extend above the plane of the second planar member 18 illustrated in FIG. 1, the straight edge 22A of the second planar member 18 need not serve as the guide line for the blade of a circular saw, but may instead be used as a guide against which a lower plate of a circular saw abuts. The rotating saw blade that cuts the sheet material is then spaced from the straight edge 22A, and the craftsman merely needs align the T-square to account for the offset between the abutting edge of the circular saw lower plate and its blade for a proper cut.

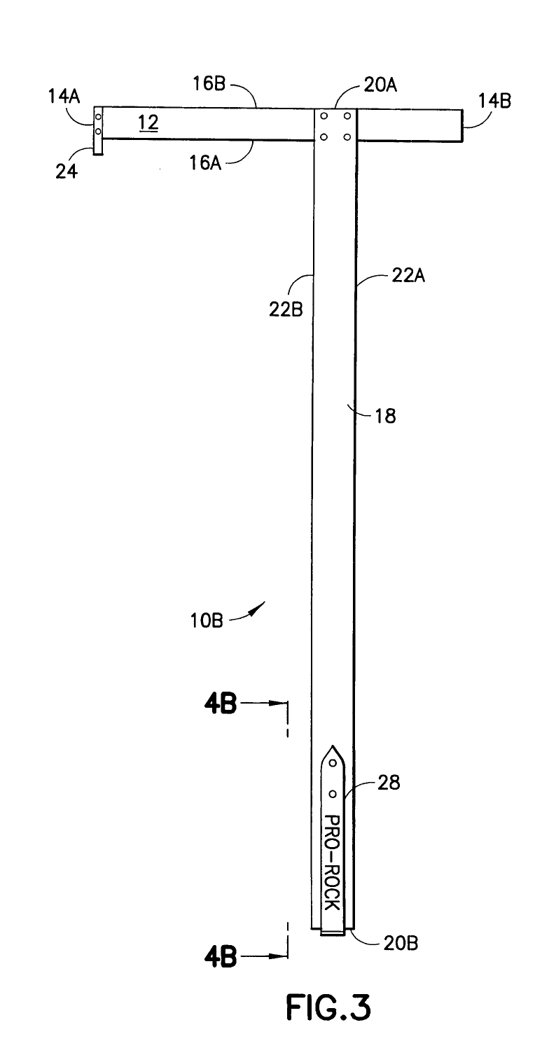

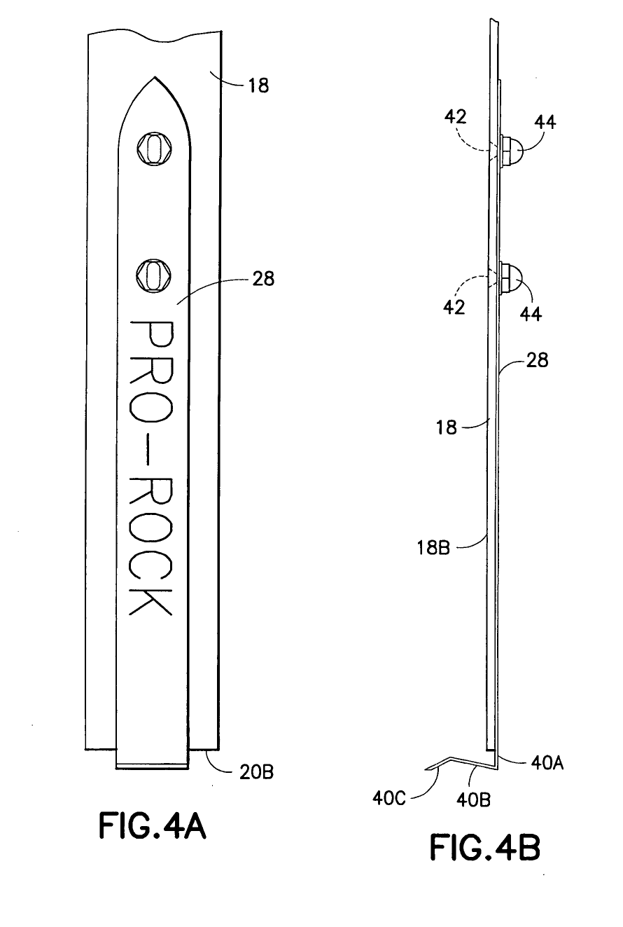

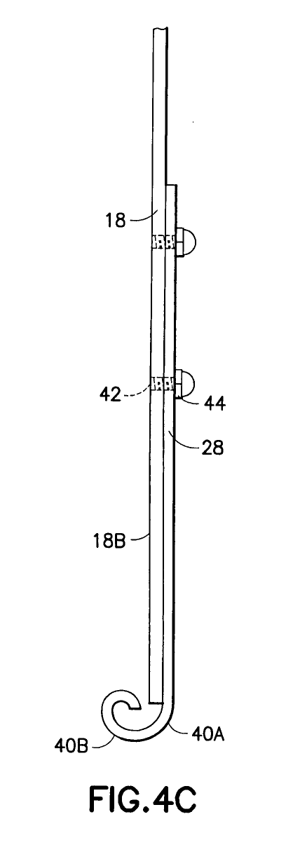

A second embodiment of the present invention is shown in FIGS. 3 and 4A-4B. Like reference numbers refer to like components and are not detailed again except to explain distinctions. The first member 12, second planar member 18, and stabilizer tab 24 are not modified in this embodiment. In place of the clamp assembly 26 of FIGS. 1 and 2A-2D, this second embodiment uses a biasing member 40. The biasing member 40 is secured to the second planar member 18 by a plate 28 that is similar to the plate of the first embodiment. However, in this second embodiment the plate 28 is relatively thin so that the screws 42 penetrate entirely through this thinner plate 28 and are held in place by nuts 44. Preferably, rounded or acorn nuts 44 are used to eliminate sharp edges that may otherwise contact a craftsman's hand. A portion of the biasing member 40 extends adjacent to the undersurface 18B of the second planar member 18, but is resiliently biased toward the straight edge 16A of the first member 12. Most preferably, while at rest, at least a portion of the biasing member lies nearer the straight edge 16A than the free end 20B so that sheet material extending from the straight edge 16A to the free end 20A is held in compression against the straight edge 16A.

As particularly shown in FIG. 4B, a first section 40A of the biasing member extends beyond the free end 20B, a second portion 40B extends nearer the straight edge 16A of the first member 12 than the free end 20B of the second planar member 18, and a third portion extends away from that same straight edge 16B of the first member 12. The biasing member is preferably spring steel, and may take other shapes other than that illustrated in FIG. 4B. For example, it may form a loop 46 as shown in FIG. 4C, made similarly of spring steel. Other embodiments are readily apparent.

For use with sheet rock, this second embodiment operates as follows, recognizing that craftsmen often score and cut with the subject sheet rock in a near vertical position. The craftsman lays an edge of the sheet rock along the floor, and inserts the third portion 40C of the biasing member 40 between the floor and the edge of the sheet rock. The craftsman then gently kicks the T-square 101B of the second embodiment near its free end 20B do that the edge of the sheet rock rests within the recess formed between the second portion 40B of the biasing member and the undersurface 18B of the second planar member 18. This may be done after placing the straight edge 16A of the first member 12 against an edge of the sheet rock that is opposed to that edge lying on the floor, or that straight edge 16A may subsequently be extended from the floor and placed against that opposed edge of the sheet rock. In each technique, the sheet rock is held securely against the undersurface 18B of the second planar member 18 and the craftsman can readily score with a thin blade along the straight edge 22A of the second planar member to achieve a perfectly straight score line along the entire 48 inch length of sheet rock. The scored sheet rock may then be snapped along the score line before or after removing the T-square 10B, which is removed in the reverse order of those techniques described above. That the second portion 40B of the biasing member 40 lies, in the rest position, nearer the straight edge 16A of the first member 12 than the free end 20B of the second planar member 18 assures that the sheet material is held in compression between those two components, at least for sheet material of the same length as that between the free end 20B and the straight edge 16A. To accommodate sheet rock in conventional sizes ranging from one-quarter inch to five-eighths inch thickness, preferably the second portion 40B extends at least five-eighths inch from the undersurface 18B of the second planar member 18.

As will be appreciated from the above, the present invention may be embodied as the clamp assembly or the biasing member with plate that are affixed to an existing, prior art T-square by any of several methods. Screws (with or without nuts) are illustrated; other affixing methods include adhesive, bolts, rivets, a pin or tab with interlocking mating surfaces, and various other securing means, both mechanical and chemical, known in the art of manufacturing tools for the construction trades. Such securing means may be permanent or removable.

Although described in the context of particular embodiments, it will be apparent to those skilled in the art that a number of modifications and various changes to these teachings may occur. Thus, while the invention has been particularly shown and described with respect to one or more preferred embodiments thereof, it will be understood by those skilled in the art that certain modifications or changes may be made therein without departing from the scope and spirit of the invention as set forth above, or from the scope of the ensuing claims.

What is claimed is:

1. A T-square comprising:
a first member defining a straight edge;
a second member mounted transverse to the first member and defining a free end spaced from the straight edge;
sheet material securing means mounted to and extending beyond said free end.

2. The T-square of claim 1 wherein the securing means comprises a clamp assembly for securing sheet material in compression against said straight edge.

3. The T-square of claim 2 wherein the clamp assembly comprises a jaw, a spring to bias the jaw away from the straight edge, and a threaded rod to overcome said bias of the spring and draw the jaw nearer the straight edge.

4. The T-square of claim 1 wherein the securing means comprises a plate affixed to a surface of the second planar member that is not co-planar with any surface of the first member.

5. The T-square of claim 1 wherein no portion of the sheet material securing means extends beyond lateral edges of the second planar member that extend between the first member and the free end.

6. The T-square of claim 1 wherein the securing means comprises a biasing member extending beyond said free end and a portion that is resiliently biased toward said straight edge.

7. The T-square of claim 6 wherein at least one point along said portion lies nearer to the straight edge of the first surface than the free end, at least when said portion is at rest.

8. The T-square of claim 7 wherein said biasing member further comprises another portion having a free end that extends away from said straight edge.

9. The T-square of claim 6 wherein said biasing member further is resiliently biased toward a surface of said second planar member that extends between said straight edge and said free end.

10. The T-square of claim 6 wherein said biasing member comprises spring steel.

11. The T-square of claim 1 further comprising a stabilizer tab mounted to an end of the first member, spaced from the second planar member, wherein both the stabilizer tab and the second planar member are mounted to a same surface of the first member.

12. An apparatus for mounting to a T-square, comprising:
a plate for securing to a planar member of a T-square near a free end of said planar member; and
coupled to the plate, means for holding sheet material in compression against said T-square.

13. The apparatus of claim 12, wherein the plate and the means do not extend beyond parallel, longitudinally extending straight edges defined by the planar member.

14. The apparatus of claim 12, wherein the means for holding extends beyond a free end of said planar member.

15. The apparatus of claim 12, wherein the means for holding comprises a clamp with a jaw that is moveable along a direction defined by the longest span of the planar member.

16. The apparatus of claim 15, wherein the means for holding comprises a biasing member that resiliently flexes and defines, at least one point, a rest position that lies a distance x from an opposed end of the planar member that is less than a distance x+y between the opposed end and the free end.
